(19) United States
(12) Patent Application Publication
(10) Pub. No.: US 2015/0343380 A1
(43) Pub. Date: Dec. 3, 2015

(54) CO2 modification

(71) Applicant: Edward Allen Zdunek, Crystal Lake, IL (US)

(72) Inventor: Edward Allen Zdunek, Crystal Lake, IL (US)

(21) Appl. No.: 14/288,647

(22) Filed: May 28, 2014

(51) Int. Cl. B01D 53/92; B01D 53/00

(52) U.S. Cl. CPC B01D 53/92; B01D 53/007

(57) ABSTRACT

In the exhaust pipe there would be one or more xray emitters. These emitters would create a radiation field that the exhaust gases would have to pass through. As the gases pass through this radiation field the covalent bonds of the gases would be broken and the atoms would have to recombine to remain stable. They would create different percentages of gases after leaving the radiation field.

The innovation uses the technology of gamma irradiation of the CO2 gases in the exhaust of automobiles.

High energy gammas or the coincidence effect of lower energy gammas have the ability to break the covalent bonds of molecules.

This currently occurs as a byproduct of gamma sterilization. During the irradiation of the product air is present within the sterilization facility. This air is also irradiated. The O2 component of the normal air has the covalent bond broke and the random recombination of the Oxygen atoms causes O2 and O3 to be formed.

In the unit automobiles an exhaust xray generator will be used in the vehicle. The design of the exhaust pipes of the vehicle will be modified to create wide but thin portion of pipe for the gas to pass through. This will not restrict the flow of the exhaust, but will provide a smaller distance for the xrays to traverse. The xray energies will be modified in conjunction with the dose rate to optimize the breakdown of the CO2 in the exhaust gases. By breaking these bonds there will be free carbon and oxygen atoms that will randomly recombine. As the plume gas is primarily nitrogen and CO2 the recombination will primarily occur with the carbon and oxygen atoms.

The recombination of the carbon and Oxygen will be random. This random recombination will produce CO, O2, O3 and CO2. The result is a smaller percentage of CO2 is exhausted from the stack. Effectively reducing the greenhouse gas emissions. This can be optimized by developing the correct dose rates and gamma energy to most effectively break down the CO2 molecules.

The gammas do not have the energy to activate molecules so there is no chance of creating any radioactive gases.

The next possible reduction in the gases would be to introduce a flame into the area where the highest percentage of breakdown is occurring. If the oxygen atoms can be used to assist the burning of the flame then a smaller number of oxygen atoms would be able to recombine.

1. This system will reduce the exhaust emissions of carbon dioxide from vehicles.

2. This system will reduce the exhaust emissions of Sulfur dioxide from vehicles.
